(19) United States
(12) Patent Application Publication
(10) Pub. No.: US 2010/0208720 A1
(43) Pub. Date: Aug. 19, 2010

(54) WIRELESS COMMUNICATION SYSTEM, INTER-BASE-STATION SYNCHRONIZATION METHOD AND BASE STATION

(75) Inventors: Kenzaburo Fujishima, Kokubunji (JP); Koki Uwano, Fujisawa (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/681,963

(22) PCT Filed: Oct. 9, 2008
(86) PCT No.: PCT/JP2008/068345

§ 371 Date: Apr. 7, 2010

(30) Foreign Application Priority Data
Oct. 9, 2007 (JP) 2007-262846

(51) Int. Cl. H04J 3/06

(52) U.S. Cl. 370/350

(57) ABSTRACT

A wireless communication system includes an asynchronized base station apparatus to perform an operation that is equivalent to the synchronization with a synchronized base station apparatus having received a sync pulse. The system includes a synchronized base station that uses a received sync pulse to synchronize itself with a base station which is a different cell, an asynchronized base station located in the cell of the synchronized base station, and a terminal. The asynchronized base station includes a unit that determines a reception timing difference, at the terminal, between a transport signal transmitted by the synchronized base station and a transport signal transmitted by the asynchronized base station, and a unit that controls the transmission timing of the asynchronized base station such that the reception timing difference becomes equal to or less than a predetermined value.

### BACKGROUND

The present invention relates to an inter-base-station synchronization method in a wireless communication system.

According to the specification for base station apparatuses described in Non-patent Document 1, two different modes, synchronous mode and asynchronous mode, are allowed to a base station apparatus. In synchronous mode, inter-base-station synchronization is carried out and in asynchronous mode, a base station operates on its own clock and inter-base-station synchronization is not carried out. A wireless communication system that includes both two different types of base stations is permitted.

As long as a terminal device carries out radio communication only with a single base station, the above difference in mode does not pose any problem. However, in a terminal device that receives radio transport signals from multiple base stations asynchronous with one another, the above difference in mode poses a problem. However, this is limited to cases where the multiple base stations respectively transmit different radio transport signals. Specifically, the foregoing is limited to cases where their respective radio transport signals do not interfere with one another and they transmit identical radio transport signals and the reception quality at the terminal device can be improved by synthesizing these radio transport signals.

The above problem is that the circuit scale at a terminal device may be incurred in soft handoff between base stations or inter-site synthesis in broadcast service. More specific description will be given. At a terminal device, radio transport signals transmitted from multiple base stations asynchronous with one another are received with different timing. Therefore, to carry out inter-site synthesis, multiple receivers that are started with different reception timing and their synthesizer are required.

To prevent increase in circuit scale at a terminal device, it is required to align the reception times of the radio transport signals with one another at the terminal device and receive a superimposed signal of multiple radio signals by one receiver. To meet this necessity, various inter-base-station synchronization methods have been proposed.

Patent Document 1 discloses a method in which the receiving times of the multiple radio transport signals are estimated at a terminal device and a difference between receiving times is fed back to each base station.

Patent Document 2 discloses a method for carrying out inter-base-station synchronization as follows: a sync timing pulse is sent from the network side and each base station receives this pulse and corrects any difference from the base station's own radio transport signal transmission timing.

Patent Document 1: Japanese Patent Application Laid-Open Publication No. 2001-268628

Patent Document 2: Japanese Patent Application Laid-Open Publication No. 2006-101252

Non-patent Document 1: 3GPP2 C. S0084-001-0 Version 2.0, “Physical Layer for Ultra Mobile Broadband (UMB) Air Interface Specification,” pp. 2-21-pp. 2-22, August, 2007

### DISCLOSURE OF THE INVENTION

Though the method disclosed in Patent Document 1 is a highly reliable inter-base-station synchronization method, however, receivers for respectively receiving the multiple asynchronous radio transport signals are required. For this reason, disadvantages of increase in the circuit scale of a terminal device and overhead due to feedback are brought.

The method disclosed in Patent Document 2 can be implemented by use of a dedicated network of a wireless communication system. However, delay fluctuation is produced in the sync pulse as a tendency to the ALL-IP network is more and more developed. It is expected that substantial inter-base-station synchronization will become difficult because of variation in sync pulse reception timing from base station to base station and variation in sync pulse arrival interval.

A problem to be solved is that at a base station apparatus (asynchronized base station), which cannot receive any sync pulses from a GPS or a time synchronization server, is caused to perform an operation that is equivalent to the synchronization with a base station apparatus (synchronized base station) having received a sync pulse.

To solve the above-mentioned problem, in the invention, there are provided a first base station (synchronized base station, high-output base station) that carries out radio communication with a terminal and a second base station (asynchronized base station, low-output base station). The invention is characterized in that: the first base station uses a received sync pulse to synchronize itself with a base station in a different cell; and the second base station is located in the cell of the first base station and includes: a unit that determines a reception timing difference between a transport signal transmitted by the first base station and a transport signal transmitted by the second base station, at the terminal; and a unit that controls the transmission timing of the second base station so that the reception timing difference becomes equal to or less than a predetermined value.

When the second base station can receive a transport signal from the first base station, the following processing is carried out at the second base station: a delay profile of a first transport signal transmitted to the second base station by the first base station is computed; the reception timing of the first transport signal at the second base station is estimated based on the delay profile; transmission timing of the first transport signal is estimated based on the estimated reception timing of the first transport signal and the distance L1 between the first base station and the second base station; reception timing of a second transport signal, transmitted from the first base station to the terminal with the same timing as the estimated transmission timing of the first transport signal, at the terminal is estimated based on the distance L2 between the first base station and the terminal; transmission timing of a third transport signal transmitted to the terminal by the second base station is estimated based on a first offset, which is the difference between the frame transmission timing of the second base station and the beginning of a delay profile window of the second base station, and a second offset, which is the difference between the estimated reception timing of the first transport signal and the beginning of the delay profile window; reception timing of the third transport signal at the terminal is estimated based on the estimated transmission timing of the third transport signal and the distance L3 between the second base station and the terminal; the reception timing difference between the estimated reception timing of the second transport signal and the reception timing of the third transport signal is estimated; and new transmission timing of the third transport signal is set based on the estimated transmission timing of the third transport signal and the estimated reception timing difference.

When the second base station cannot receive a transport signal from the first base station, the following processing is carried out at the second base station: reception timing of a fourth transport signal, transmitted from the terminal to the second base station, at the second base station is estimated; a reception timing of a fifth transport signal, transmitted from the terminal to the first base station, at the first base station is estimated based on the propagation path difference between the distance L4 between the terminal and the second base station and the distance L5 between the terminal and the first base station; transmission timing of the first base station is estimated based on the difference between transmission frame timing and reception frame timing at the second base station and the reception timing of the fifth transport signal; first reception timing of a first down signal, transmitted from the first base station to the terminal, at the terminal is estimated based on the distance L5; and new transmission timing of a second down signal transmitted from the second base station to the terminal is set based on the reception timing of the down signal and the distance L4.

### EFFECTS OF THE INVENTION

According to the invention, a state equivalent to inter-base-station synchronization can be implemented using a reference signal commonly used in radio transmission systems. Therefore, the receiver configuration of a terminal device can be simplified in soft handover between base stations in a wireless communication system or inter-base-station synthesis in broadcast service and necessity for addition of a function to the terminal device is obviated.

A method in which timing of receiving signals from base stations at a terminal device is aligned can be implemented using a reference signal commonly used in wireless communication systems without strictly aligning signal transmission timing between base station apparatuses. Further, use of the invention makes it unnecessary to provide a base station apparatus with a synchronizing unit such as a GPS and thus the circuit scale and price of the base station apparatus can be reduced.

### BEST MODE FOR CARRYING OUT THE INVENTION

Hereafter, detailed description will be given to a wireless communication system to which the invention is applied with reference to the drawings.

### First Embodiment

FIG. 1 illustrates an example of the wireless communication system.

An asynchronized cell 104 formed by an asynchronized base station 103 that operates with its own timing is included in a synchronized cell 102 formed by a synchronized base station 101 synchronized with multiple synchronized base stations 101. There is one or more asynchronized cells 104 in the synchronized cell 102. The synchronized base stations 101 are high-output base stations. Meanwhile, the asynchronized base stations 103 are low-output base stations as compared with the synchronized base stations 101. The synchronized cells 102 are arranged so that the distance between synchronized base stations 101 is several hundreds to several thousands of meters. Each asynchronized cell 104 covers a radius of several tens to several hundreds of meters. The asynchronized base stations 103 are often installed in places, such as indoor areas and basements, where inter-base-station synchronization is generally recognized to be difficult. Needless to add, the asynchronized base station 103 may be installed outdoors. The area of a synchronized cell 102 or an asynchronized cell 104 may be varied according to traffic or the like as appropriate.

A first embodiment is based on the assumption that the asynchronized base station 103 can receive transport signal A as a down signal from the synchronized base station 101.

FIG. 2 illustrates an example of the network configuration of the above wireless communication system. One or more terminal devices A: 105 belong to each synchronized base station 101 and each asynchronized base station 103. A base station-terminal radio link is used to transmit and receive signals. (When mention is hereafter simply made as base station, that includes both synchronized base station 101 and asynchronized base station 103.) The synchronized base stations 101 and the asynchronized base stations 103 belong to one base station controller 107 and control information and information on terminal device user data are communicated between the base station controller 107 and each base station.

In general, this part is formed of a wired network; however, the base station controller 107 and each base station may be wirelessly connected together. Multiple base station controllers 107 belong to one gateway 108 and control information and information on terminal device user data are communicated between each base station controller 107 and the gateway 108.

The gateway 108 functions to terminate an IP network 109 and terminate the networks of the base station controllers 107 and the devices ranked therebelow. It carries out conversion between an Internet protocol (IP) and dedicated protocols used at the base station controllers 107 and the devices ranked therebelow.

FIG. 3 illustrates an example of radio communication between devices. The terminal device A: 105 receives the following transport signals in a superimposed manner in a cell boundary where it receives respective transport signals from multiple base stations: a transport signal 201 from a synchronized base station 101 and a transport signal 202 from an asynchronized base station 103.

The synchronized base station 101 transmits transport signal A: 203 and transport signal B: 201 with the same timing. The transport signal A and the transport signal B may be identical signals or may non-identical signals.

The asynchronized base station 103 transmits transport signal C: 202 to the terminal device A: 105. The asynchronized base station 103 controls the transmission timing of the transport signal C: 202 on the assumption that the transport signal A and the transport signal B are transmitted with the same timing. The transport signal C: 202 is transmitted by the asynchronized base station 103 so that the difference in reception timing between the radio transport signal B: 201 and the radio transport signal C: 202 at the terminal device A: 105 falls within an allowable range.

FIG. 4 illustrates an example of transmission/reception timing at each base station and each terminal device. Time when each base station transmits a signal occurs at certain intervals (frame intervals). This frame interval takes a constant value regardless of whether the base station is a synchronized base station 101 or an asynchronized base station 102.

The synchronized base station 101 agrees with any other synchronized base station 101 in transmission timing (inter-base-station synchronization). In general, the asynchronized base station 103 disagrees with the synchronized base station 101 and any other asynchronized base station 103 in transmission timing.

Reception timing of transport signals from the two base stations at the terminal device is determined by the wireless propagation distance between each base station and the terminal device and the transmission timing of each transport signal. The allowable range of delay in the drawing indicates the allowable range of reception timing difference. The transmission timing of the asynchronized base station 103 is shifted so that the transport signals from the two base stations are received at the terminal device within this range.

This allowable range of reception timing difference is equivalent to GI (Guard Interval) or CP (Cyclic Prefix) in, for example, a wireless communication system using OFDMA.

In general, it is not easy to precisely align radio signal transmission timing between base stations. To cope with this, the invention adopts the approach of aligning reception timing of radio transport signals from multiple base stations at a terminal device.

In the OFDM (Orthogonal Frequency Division Multiplexing) transmission method, for example, GI (Guard Interval) or CP (Cyclic Prefix) for avoiding inter-symbol interference is added to between OFDM symbols.

Consequently, the receiving times of radio transport signals from multiple base stations only have to fall within the range of GI or CP. When this condition is met, a superimposed signal of radio transport signals from the multiple base stations can be received by one OFDM receiver and this makes it unnecessary to increase the circuit scale of the above-mentioned terminal device.

FIG. 5 is a state transition diagram of the asynchronized base station 103 in the invention. In the asynchronized base station 103, there are three states, asynchronous mode, calibration mode, and synchronous mode.

After power is turned on, the asynchronized base station 103 is started in asynchronous mode. This is a mode in which the asynchronized base station 103 generates transmission timing in accordance with its own clock.

The calibration mode is a mode in which the transmission timing of the asynchronized base station 103 itself is shifted to align the transmitting times of transport signals at the terminal device A: 105.

The synchronous mode is a state in which receiving times of transport signals are aligned at the terminal device A: 105. This state is equivalent to the synchronized base station 101 and can be a reference for any other asynchronized base station 103. That is, any other asynchronized base station can use a signal (transport signal C in FIG. 3) transmitted by the asynchronized base station 103 brought into synchronous mode to control transmission timing.

A trigger for transition from asynchronous mode to calibration mode is issued after the following processing is carried out: the radio signal A: 203 is received from a synchronized base station 101, a receiving time at the relevant asynchronized base station 103 is estimated, and then a transmitting time as a target of the asynchronized base station 103 (target transmitting time) is computed.

A trigger for transition from calibration mode to synchronous mode is issued when a transmitting time of the asynchronized base station 103 is aligned with the above target transmitting time.

A trigger for transition from synchronous mode to asynchronous mode is issued when the reception level of the radio signal A: 203 referred to by the asynchronized base station 103 is reduced to a value equal to or less than a threshold value.

A trigger for transition from synchronous mode to calibration mode is issued when a receiving time of the radio signal A: 203 at the asynchronized base station 103 referred to by the asynchronized base station 103 slips for a certain time or longer.

FIG. 6 is a flowchart of the operation of the asynchronized base station 103 in the first embodiment in asynchronous mode.

First, it is determined whether or not a transport signal has been received from any other base station (1001). A receive signal is subjected to correlation calculation using a reference signal transmitted by each base station. (The reference signal is a signal different from transmitting base station to transmitting base station, known to the asynchronized base station 103 as the receiving side. The PN (Pseudo Noise) series, M (Maximum-Length) series, or CAZAC (Constant Amplitude Zero Auto-Correlation) series is generally used.) When the peak value of the correlation calculation exceeds a threshold value, it is determined that a transport signal has been received. When it is determined that it has not been received, this determination (1001) is repeated.

When a transport signal has been received from any other base station, it is determined whether or not the base station is a synchronized base station 101 (1002). To determine whether or not the base station is a synchronized base station 101, an indicator for synchronization/asynchronization notified as control information to the terminal device 105 by the synchronized base station 101 is referred to. When this determination is No, the flow returns to Step 1001.

When transport signals have been received from a synchronized base station 101, one of the transport signals is defined as reference signal and its receiving time is estimated (1003).

Using the estimated receiving time, target transmission timing and the offset of the target transmission timing from the current transmission timing are calculated (1004).

Thereafter, a transition from asynchronous mode to calibration mode occurs (1005).

FIG. 7 is a flowchart of the operation of the asynchronized base station in the first embodiment in calibration mode.

First, the current transmission timing is set as temporary transmitting time (abbreviated as TTT in the drawing) (1101).

This TTT is updated at certain intervals (for example, at intervals of one frame). It is determined whether or not this update time has come (1102). When an update time has not come, this determination is repeated until an update time comes.

Each time an update time has come, the transmission timing is shifted (increased or decreased) by the ticks of clock equivalent to the update step (1103).

It is determined whether or not the difference between the updated transmission timing and the target transmission timing is equal to or less than a threshold value (for example, two ticks of clock) (1104). When this determination is NO, the flow returns to Step 1102.

When the above determination is YES, the TTT updated so far is fixed as the current transmission timing (1105).

Thereafter, a transition from calibration mode to synchronous mode occurs (1106).

FIG. 8 is a flowchart of the operation of the asynchronized base station 103 in the first embodiment in synchronous mode.

In synchronous mode, the asynchronized base station 103 continuously monitors the reception level and reception timing of the above transport signal. It is determined whether or not the reception level is less than a threshold value (1201).

When the reception level is less than the threshold value, it is determined whether or not this has occurred once or successively more than once (1202).

When it has successively occurred, a transition from synchronous mode to asynchronous mode occurs (1203) and re-search for a reference signal is started. When it has not successively occurred, the flow returns to Step 1201.

When the reception level is not less than the threshold value at Step 1201, subsequently, attention is paid to reception timing. It is determined whether or not timing deviation equal to or more than a threshold value has occurred after the transition to synchronous mode (1204). When the determination is No, the flow returns to Step 1201.

It is continuously determined whether or not timing deviation equal to or more than the threshold value has occurred once or successively more than once (1205). The determination is No, the flow returns to Step 1201.

When timing deviation equal to or more than the threshold value has successively occurred more than once, a transition from synchronous mode to calibration mode occurs to measure timing again (1206).

FIG. 9 illustrates a procedure for determining transmission timing at the asynchronized base station 103 in the first embodiment and FIG. 10 is a transmission/reception timing chart related to this procedure.

First, a delay profile of a reference signal is generated at the asynchronized base station 103 and the reception timing of the transport signal A is estimated from the result thereof (1301).

Using the result of Step 1301 and a time equivalent to the distance La between the base stations (the propagation distance of the transport signal A), the timing with which the synchronized base station 101 transmitted the radio signal A is estimated (1302).

The reception timing of the radio signal B at the terminal device is estimated using the following: the result of Step 1302 and a time equivalent to the distance Lb between the synchronized base station and the terminal device (the propagation distance of the transport signal B) (1303).

Subsequently, the reception timing of the transport signal C at the terminal device is estimated using the following: the transmission timing of the asynchronized base station and the propagation distance Lc of the transport signal (the propagation distance of the transport signal C). The transmission timing of the asynchronized base station 103 is estimated from three items: the reception timing of the radio signal A estimated at Step 1301; a timing difference between this reception timing and the beginning of the delay profile window (Offset B); and a time difference between the frame transmission timing of the asynchronized base station and the beginning of the delay profile window (Offset A). The first two items can be clearly known from the result of timing estimation. Offset A can be defined as a design value of the base station apparatus. The foregoing is carried out at Step 1304.

The estimated reception timing difference between the transport signal B and the transport signal C is estimated from the results of Step 1303 and Step 1304 (1305).

Target transmission timing is calculated from this timing difference and the transmission timing of the asynchronized base station at the present time determined at Step 1304 (1306).

The above propagation distances La, Lb, and Lc can be calculated based on the following when a base station apparatus is installed: the coordinates (plane rectangular coordinates in the Tokyo datum or the world geodetic system) of the base station and the coordinates of a terminal device. An arbitrary point in the line forming the cell boundary between a synchronized base station and an asynchronized base station is taken for the coordinates of the terminal device. At this time, it is required that the accuracy of each coordinate should be sufficiently lower than a value obtained by multiplying the allowable range of the reception timing difference of the terminal device by the speed of light to achieve the object of the invention. When the allowable range is 10[us], its equivalent distance value is 10[us]×3×10̂8[m/s]=3000[m]. When it is assumed that the influence of coordinate error is nestled into 1% or less with respect to this value, 3000[m]×0.01=30[m]. Since this error is the sum of errors in two coordinates, the accuracy required of each coordinate is 15[m].

The time equivalent to the above propagation distance (La, Lb, and Lc) is calculated by dividing the propagation distance [m] by the speed of light (3.0×10̂8[m/s]).

FIG. 11 illustrates an example of the configuration of the asynchronized base station 103 in the first embodiment.

A network I/F 2001 transmits and receives control information and data signals the base station wirelessly communicates with a terminal device to and from a base station controller. The network I/F 2001 is comprised of a hard or soft network interface, a controller such as CPU, and a buffer for storing data.

A demodulation unit 2002 demodulates radio signals from a terminal device, decodes a channel coding, and decodes a source coding. A bit series that underwent the above processing is transmitted to the network I/F 2001. The FFT processing in OFDMA and the despread processing in CDMA are also included in this. The demodulation unit 2002 can be implemented by a logic circuit or a processor such as DSP.

A modulation unit 2003 carries out source coding, propagation path coding, and modulation on bit strings inputted from the network I/F 2001 and outputs them to a radio I/F 2008. It does the above output when triggered by frame transmission timing inputted from a frame timing generation unit 2004. The modulation unit 2003 can be implemented by a logic circuit or a processor such as DSP.

The frame timing generation unit 2004 internally counts clock and outputs frame transmission timing to the modulation unit 2003 when it counts the number of ticks of clock equivalent to frame length. To shift transmission timing, the clock count equivalent to frame length is temporarily made variable. The frame timing generation unit 2004 can be implemented by a crystal oscillator for clocking, a logic circuit for transmitting clock counts and frame timing pulses to the modulation unit, and a processor for controlling frame length variation.

A target timing generation unit 2005 carries out the following processing using the estimated reception timing and the current frame transmission timing in accordance with the flowchart in FIG. 9: it determines target transmission timing and it calculates the difference between the current transmission timing and the target transmission timing (amount of shift in transmission timing that occurs at frame intervals). This calculation can be implemented by a processor such as DSP.

A state management unit 2006 manages the three states, asynchronous mode, calibration mode, and synchronous mode, illustrated in FIG. 5 and notifies each functional block of change of state. State management can be implemented by a processor such as DSP.

A reception signal estimation unit 2007 generates a delay profile to measure the reception timing and reception level of a radio signal received at the radio I/F. Generation of a delay profile is implemented by a logic circuit for implementing a matched filter. Determination of reception timing and reception level from a delay profile is implemented by a processor such as DSP.

The radio I/F 2008 carries out conversion of base band signals in the equivalent low pass system and RF signals in the band system and digital/analog conversion. It is comprised of an A/D converter, a D/A converter, a frequency oscillator, a power amplifier, a low-noise amplifier, a filter, and a duplexer.

Reference numeral 2009 denotes a transmitting and receiving antenna.

FIG. 12 illustrates the configuration of the reception signal estimation unit 2007 in the invention.

A reception signal estimation unit control block 2101 manages the internal state of the reception signal estimation unit illustrated in FIG. 13 and notifies a reference signal search block 2102 and a delay profile generation block 2104 of this state. The reception signal estimation unit control block 2101 notifies the target timing generation unit 2005 of the reception timing of some transport signal. The reception signal estimation unit control block 2101 has the three states, asynchronous mode, calibration mode, and synchronous mode, illustrated in FIG. 5 in common with the state management unit 2006.

The reference signal search block 2102 changes reference signals different from transmission source to transmission source and carries out correlation calculation between them and receive signals. Then it notifies a reference signal selection block 2103 of a reference signal whose reception level exceeds a threshold value.

The reference signal selection block 2103 notifies the reception signal estimation unit control block 2101 of a reference signal whose reception level is highest based on the result notified from the reference signal search block 2102.

The delay profile generation block 2104 as a delay profile generating unit generates a delay profile of the reference signal selected at the reference signal selection block 2103. Then it notifies a reception timing estimation block 2105 of the maximum value exceeding the threshold value and its timing.

The reception timing estimation block 2105 determines the reception timing of the reference signal based on the result notified from the delay profile generation block 2104 and notifies the reception signal estimation unit control block 2101 of it.

FIG. 13 illustrates the internal state of the reception signal estimation unit 2007 in the asynchronized base station 103 in the first embodiment.

The reception signal estimation unit is brought into the following states: a state in which a transport signal to be referred to has not been captured immediately after power-on (no reference signal); a state in which a transport signal to be referred to has been identified but estimation of its reception timing has not been completed (reference signal estimating); and a state in which a transport signal to be referred to has been identified and estimation of its reception timing has been completed (reference signal tracking). In the reference signal tracking state, the reception timing and reception level of the reference signal are continuously observed and a transition to the two other states depending on the result of this observation.

FIG. 14 is a flowchart of the processing of the reception signal estimation unit 2007 of the asynchronized base station 103 in the no reference signal state.

In this state, the reference signal search block 2102 is in operation and the delay profile generation block 2104 is at a stop (3001).

When as the result of the operation of the reference signal search block 2102, the reception level of the received reference signal becomes equal to or higher than a threshold value, a search result is notified from the reference signal selection block 2103. It is determined whether or not this notification has been received (3002). When the notification has not been received, this determination is repeated.

In response to the reception of this notification, a reference signal used at the delay profile generation block 2104 is determined (3003).

Thereafter, the reference signal search block 2102 is stopped and the delay profile generation block 2104 is actuated (3004).

In conjunction with this, the internal state of the reception signal estimation unit is caused to transition from the no reference signal state to the reference signal estimating state (3005). Then the state of the entire base station apparatus is caused to transition from asynchronous mode to calibration mode (3006).

FIG. 15 is a flowchart of the processing of the reception signal estimation unit 2007 of the asynchronized base station 103 in the reference signal estimating state.

In this state, the reference signal search block 2102 is at a stop and the delay profile generation block 2104 is in operation (3101).

The delay profile generation block 2104 generates a delay profile and the reception timing estimation block 2105 notifies the reception signal estimation unit control block 2101 of the reception timing of the reference signal based on the result thereof. It is determined whether or not this notification has been made (3102). When the notification has not been made, this determination is repeated.

When the notification has been made, the target timing generation unit 2005 is notified of the above reception timing (3103).

Thereafter, the delay profile generation block 2104 adjusts the window position of the delay profile so that the receiving time comes to the center of the window position (3104). Then the internal state of the reception signal estimation unit is caused to transition from the reference signal estimating state to the reference signal tracking state (3105).

FIG. 16 is a flowchart of the processing of the reception signal estimation unit 2007 of the asynchronized base station 103 in the reference signal tracking state.

When the asynchronized base station 103 is in calibration mode, the reception signal estimation unit control block 2101 waits until it transitions to synchronous mode (3201).

When a mode transition occurs, the window position of the delay profile generated at the delay profile generation block 2104 is shifted by an amount equivalent to the transmission timing shifted during calibration mode (3202). In synchronous mode, the following processing is repeated until a mode transition occurs.

First, a delay profile of the reference signal is generated at the delay profile generation block 2104 at certain intervals (for example, frame intervals). Then an offset of the reception timing of the reference signal from the delay profile center and the reception level are estimated (3203).

When the offset exceeds a threshold value (3204) and this occurs once or successively more than once (3205), determination of the reception level of the reference signal is carried out (3206). When the determination at Step 3204 or Step 3205 is No, the flow returns to Step 3203.

When the reception level is less than the threshold value (the determination at Step 3206 is Yes), the internal state of the reception signal estimation unit is caused to transition from the reference signal tracking state to the no reference signal state (3207). Then the mode of the asynchronized base station 103 is caused to transition from synchronous mode to asynchronous mode (3208).

In conjunction with this, the reference signal search block 2102 is started and the delay profile generation block 2104 is stopped (3209).

The above reception level is not less than the threshold value (the determination at Step 3206 is No), the following processing is carried out to re-search the reception timing with the reference signal kept fixed: the internal state of the reception signal estimation unit is caused to transition from the reference signal tracking state to the reference signal estimating state (3210); and the mode of the asynchronized base station 103 is caused to transition from synchronous mode to calibration mode (3211).

FIG. 17 illustrates an example of an output result of the reference signal search block 2102 of the asynchronized base station 103.

The reference signal search block 2102 changes reference signals and carries out correlation calculation using a matched filter to estimate the reception level of each reference signal. Different reference signals are used from signal transmission source to signal transmission source. Examples of reference signals include the PN series, M series, and CAZAC series.

An ID number is assigned to each reference signal and each reception level estimation result is stored in memory in the format illustrated in the drawing. When reception level estimation is completed with respect to all the reference signals expected to be received, the following processing is carried out: the reference signal selection block 2103 selects a reference signal highest in reception level and notifies the reception signal estimation unit control block 2101 of this result.

At the delay profile generation block 2104, a delay profile is generated with respect to only the selected reference signal. This will be designated as the fixation of a reference signal.

FIG. 18 illustrates an example of an output result of the delay profile generation block 2104 of the asynchronized base station 103.

The delay profile generation block 2104 is notified of the reference signal selected by the reference signal selection block 2103 from the reception signal estimation unit control block 2101. Then it generates a delay profile by a matched filter and records the maximum value exceeding a threshold value and its timing in memory in the format illustrated in FIG. 18.

The reception timing estimation block 2105 selects the reception timing highest in reception level (maximum value) or the earliest reception timing from the table in FIG. 18 and notifies the reception signal estimation unit control block 2101 of this result.

FIG. 19 illustrates the configuration of the target timing generation unit 2005 in the asynchronized base station 103.

The target timing generation unit control block 2201 carries out I/F with the outside and management of the internal state illustrated in FIG. 20. A target timing calculation block 2202 calculates target transmission timing and the difference between the current transmission timing and the target transmission timing using the following: the reception timing and transmission timing at the present time of the reference signal and information of the propagation distance of a radio signal. An offset information storage memory 2203 is a memory for storing propagation distance information required for target timing calculation.

FIG. 20 illustrates the internal state of the target timing generation unit 2005.

Immediately after power-on, it is in a timing fixed state in which transmission timing (that is, frame interval) is fixed. When target transmission timing is determined, a timing change state in which the frame interval is variable and the transmission timing is shifted is established.

FIG. 21 is a flowchart of the processing of the target timing generation unit 2005 in the timing fixed state.

This state is established when the base station apparatus is in synchronous mode or asynchronous mode and in this state, the frame interval is kept constant. First, it is monitored whether or not start of calibration mode has been notified from the state management unit 2006 (3301). When the notification has been received, a transition to the timing change state occurs (3302).

When the notification has not been received, a frame timing pulse (pulse issued at frame intervals) from the frame timing generation unit 2004 is monitored (3303). When this frame timing pulse has been received, by how many ticks of clock this frame interval is offset from that immediately after start-up is calculated (3304). This is a figure indicating how much it presently deviates from a design value and relates to increase/decrease in Offset A in FIG. 10. When a frame timing pulse has not been received at Step 3303, the flow returns to Step 3301.

FIG. 22 is a flowchart of the processing of the target timing generation unit 2005 of the invention in the timing change state.

First, target transmission timing is calculated at the target timing calculation block 2202 in accordance with the procedure illustrated in FIG. 9 (3401). Then the offset of the target transmission timing from the current transmission timing is notified to the frame timing generation unit 2004 (3402). The internal state of the target timing generation unit 2005 is caused to transition from the timing change state to the timing fixed state (3403).

FIG. 23 illustrates an example of the format for recording to the offset information storage memory 2203.

With respect to each reference signal ID, the following information is stored: the propagation distance (La) between a reference signal transmission source and the asynchronized base station 103; the propagation distance (Lb) between the reference signal transmission source and the cell edge of the asynchronized base station; and the propagation distance (Lc) between the asynchronized base station and the cell edge thereof, that is, the cell radius.

FIG. 24 illustrates the configuration of the frame timing generation unit 2004 of the asynchronized base station 103.

A frame timing generation unit control block 2301 carries out I/F with the outside and management of the internal state illustrated in FIG. 20. It also counts clock generated by a clock generation block 2302 and issues a frame timing pulse according to the count value. The clock generation block 2302 generates clock by a crystal oscillator.

FIG. 25 is a flowchart of the processing of the frame timing generation unit control block 2301.

First, a clock counter is initialized to zero (3501) and the clock counter is incremented each time a clock pulse is generated from the clock generation block 2302 (3502). It is determined whether or not the clock count value has reached a value equivalent to a frame interval (3503). When it has reached the equivalent value, a frame timing pulse is issued to the outside (3504). When the offset notified at Step 3402 in FIG. 22 is larger than a threshold value at this time (3505), the clock value equivalent to the frame interval is increased or decreased so that the offset is reduced (3506) and the offset is thereby increased or decreased (3507).

FIG. 26 illustrates an example of the configuration of the synchronized base station 101.

A network I/F 2001 transmits and receives control information and data signals the base station wirelessly communicate with a terminal device to and from a base station controller. The network I/F 2001 is comprised of a hard or soft network interface, a controller such as CPU, and a buffer for storing data.

A demodulation unit 2002 demodulates radio signals from a terminal device, decodes a channel coding, and decodes a source coding. A bit series that underwent the above processing is transmitted to the network I/F 2001. The FFT processing in OFDMA and the despread processing in CDMA are also included in this. The demodulation unit 2002 can be implemented by a logic circuit or a processor such as DSP.

A modulation unit 2003 carries out source coding, propagation path coding, and modulation on bit strings inputted from the network I/F 2001 and outputs them to a radio I/F 2008. A reference signal received by an asynchronized base station 103 is generated here. Signals, including a reference signal, generated here are received at an asynchronized base station 103 or a terminal device 105. Transmission of the above signals is carried out when triggered by frame transmission timing inputted from a frame timing generation unit 2004. The modulation unit 2003 can be implemented by a logic circuit or a processor such as DSP.

The frame timing generation unit 2004 internally counts clock and outputs frame transmission timing to the modulation unit 2003 when it counts the number of ticks of clock equivalent to frame length. The offset between a pulse inputted from a sync pulse generation unit 2010 at equal intervals and a frame timing pulse generated by the frame timing generation unit 2004 itself is measured. The timing of frame timing pulse generation is controlled so that this offset becomes equal to 0. The frame timing generation unit 2004 can be implemented by: a crystal oscillator for clocking; a logic circuit for transmitting clock counts and frame timing pulses to the modulation unit, and a processor that controls frame length variation for compensating deviation from a sync pulse.

The radio I/F 2008 carries out conversion of base band signals in the equivalent low pass system and RF signals in the band system related to radio signals communicated between the base station and a terminal and digital/analog conversion. It is comprised of an A/D converter, a D/A converter, a frequency oscillator, a power amplifier, a low-noise amplifier, a filter, and a duplexer.

Reference numeral 2009 denotes a transmitting and receiving antenna related to radio signals communicated between the base station and a terminal device.

The sync pulse generation unit 2010 inputs a pulse of 1 PPS received through a GPS antenna 2011 and a radio I/F 2012 for GPS to the frame timing generation unit 2004. There are existing devices as a GPS module for the sync pulse generation unit 2010, GPS antenna 2011, and radio I/F 2012 for GPS.

At the synchronized base station 101, frame timing synchronized with 1 PPS pulse of a GPS is generated; therefore, signal transmitting times are synchronized between synchronized base stations. This is the same with the reference signal generated at the modulation unit 2003. This reference signal is received at the reception signal estimation unit 2007 of an asynchronized base station 103. The transmission timing (frame timing) of an asynchronized base station is controlled using the result of estimation of reference signal reception timing. As a result, the receiving times of the following transport signals are aligned with each other at a terminal device: a transport signal of a synchronized base station 101 and a transport signal of an asynchronized base station 103.

FIG. 27 illustrates an example of the configuration of the terminal device 105.

A user I/F 2013 is a function for conversion between audio and visual data and bit series and is comprised of a picture display unit, an output unit such as a speaker, an input unit such as a microphone and a keyboard, a processor for source coding and decoding, and a buffer for holding bit series.

A demodulation unit 2002 demodulates radio signals from a base station and decodes a channel coding. A bit series that underwent the above processing is transmitted to the user I/F 2013. The FFT processing in OFDMA and the despread processing in CDMA are also included in this. The demodulation unit 2002 can be implemented by a logic circuit or a processor such as DSP.

A modulation unit 2003 carries out propagation path coding and modulation on bit strings inputted from the user I/F 2013 and outputs them to a radio I/F 2008. A reference signal received by an asynchronized base station 103 is generated here. Signals, including a reference signal, generated here are received at an asynchronized base station 103 or a synchronized base station 101. Transmission of the above signals is carried out when triggered by frame transmission timing inputted from a timing generation unit 2004. The modulation unit 2003 can be implemented by a logic circuit or a processor such as DSP.

The frame timing generation unit 2004 internally counts clock and outputs frame transmission timing to the modulation unit 2003 when it counts the number of ticks of clock equivalent to frame length. The frame timing generation unit 2004 can be implemented by: a crystal oscillator for clocking; a logic circuit for transmitting clock counts and frame timing pulses to the modulation unit; and a processor that controls frame length variation for compensating deviation from a sync pulse.

The radio I/F 2008 carries out conversion of base band signals in the equivalent low pass system and RF signals in the band system related to radio signals communicated between a base station and the terminal device and digital/analog conversion. It is comprised of an A/D converter, a D/A converter, a frequency oscillator, a power amplifier, a low-noise amplifier, a filter, and a duplexer.

Reference numeral 2009 denotes a transmitting and receiving antenna related to radio signals communicated between a base station and the terminal device.

FIG. 28 illustrates an example of signals between devices in the first embodiment.

The synchronized base station 101 and the asynchronized base station 103 transmit reference signals and data signals to the terminal device. The asynchronized base station 103 receives the reference signal transmitted by the synchronized base station 101 and controls transmission timing in accordance with the procedure illustrated in FIG. 9. In the example in this drawing, the frame interval of the asynchronized base station 103 is temporarily shortened to align the following receiving times at the terminal device with each other: the receiving time of the transport signal from the synchronized base station 101 and the receiving time of the transport signal from the asynchronized base station 103. The frame interval of the synchronized base station is constant.

By the above operation, the following can be implemented at a terminal device located at the cell boundary between a synchronized base station 101 and an asynchronized base station 103 when both the base stations are transmitting identical data signals to achieve soft handover or broadcast: the transport signals from the base stations can be synthesized and received without complicating its reception circuitry and further the transmission power of each of the synchronized base station 101 and the asynchronized base station 103 can be suppressed.

### Second Embodiment

FIG. 29 illustrates another example of the configuration of the wireless communication system.

A second embodiment is different from the first embodiment in that: it is based on the assumption that the asynchronized base station 103 cannot receive a down signal from the synchronized base station 101.

A transport signal D: 204 and a transport signal E: 205 transmitted by a terminal device A: 105 are respectively received at a synchronized base station 101 and an asynchronized base station 103. Whether or not the transport signal D and the transport signal E are identical is irrelevant. It is an important presupposition of the invention that they are transmitted with the same timing. A transport signal F: 206 transmitted by a terminal device B: 106 is received at the asynchronized base station 103.

A difference from the first embodiment is in that in place of a transport signal from a synchronized base station, transport signals from terminal devices are used for control.

FIG. 30 illustrates a procedure for determining target transmission timing in the second embodiment of the invention.

FIG. 31 is a timing chart related to transmission timing determination at an asynchronized base station.

This procedure is equivalent to the procedure in FIG. 9 in relation to the first embodiment and is carried out at the target timing generation unit illustrated in FIG. 19. The second embodiment is implemented by the same devices and method as in the first embodiment except the difference between the target timing determination procedure illustrated in FIG. 9 and that illustrated in FIG. 30 and except that: at the reception signal estimation unit illustrated in FIG. 12, a signal transmitted by a terminal device is taken as a reference signal.

First, the reception timing of the radio signal E is estimated at the asynchronized base station (4001). Here attention should be paid to that a reference signal transmitted to the synchronized base station by the terminal device A is used. This is because the reception timing of this signal at the asynchronized base station and an estimated value of the reception timing of the same at the synchronized base station contribute to determination of target transmission timing.

The propagation path difference between the propagation path length Le between the terminal device A and the asynchronized base station and the propagation path length Ld between the terminal device A and the synchronized base station is converted into a time. The thus obtained value is added to or subtracted from the result of Step 4001. The estimated reception timing of the radio signal D at the synchronized base station is thereby calculated (4002).

Subsequently, the difference (Δfrm) between the transmission frame timing and the reception frame timing in the synchronized base station is added to or subtracted from the result of Step 4002 to estimate the transmission frame timing, that is, the transmission timing of the synchronized base station (4003). Δfrm is a fixed value dependent on the implementation of a logic circuit. Time alignment is carried out and the transmission timing of the terminal device is controlled in accordance with reception frame timing expected at the base stations.

Subsequently, a value obtained by converting the propagation path length Ld between the terminal device A and the synchronized base station into a time is added to or subtracted from the result of Step 4003. The reception timing of the transport signal from the synchronized base station, or a down signal from the synchronized base station, at the terminal device A is thereby estimated (4004).

A value obtained by converting the propagation path length Le between the terminal device A and the asynchronized base station into a time is added to or subtracted from the result of Step 4004. The target transmission timing of the transport signal from the asynchronized base station is thereby estimated (4005).

The offset of the result of Step 4005 from the current transmission timing of the asynchronized base station is calculated (4006).

As in the first embodiment, the above propagation distances Ld and Le can be calculated based on the following when a base station apparatus is installed: the coordinates (plane rectangular coordinates in the Tokyo datum or the world geodetic system) of the base station and the coordinates of the terminal device. An arbitrary point in the line forming the cell boundary between a synchronized base station and an asynchronized base station is taken for the coordinates of the terminal device.

The time equivalent to the above propagation distance (Ld and Le) is calculated by dividing the propagation distance [m] by the speed of light (3.0×10̂8[m/s]).

According to the above configuration, the asynchronized base station 103 operates in accordance with the procedure illustrated in FIG. 27 and a signal transmitted by a terminal device is used as a reference signal. As in the first embodiment, as a result, the transmission timing from the asynchronized base station 103 is controlled and the following is implemented: the reception timing difference between a transport signal from the synchronized base station 101 and a transport signal from the asynchronized base station 103 is nestled into an allowable range at the terminal device A 105 located at the cell boundary.

FIG. 32 illustrates an example of signals between devices in the second embodiment.

The synchronized base station 101 and the asynchronized base station 103 transmit reference signals and data signals to terminal devices. The terminal device A is located at the cell boundary where it can receive transport signals from both the base stations. The terminal device A transmits a reference signal and a data signal to the synchronized base station 101 a certain time after it received the transport signal from the synchronized base station 101. This signal can also be observed at the asynchronized base station. The terminal device B transmits a reference signal and a data signal to the asynchronized base station 103 a certain time after it received the transport signal form the asynchronized base station 103. The asynchronized base station 103 measures the reception timing of each of the transport signal from the terminal device A and the reference signal transmitted from the terminal device B. Then the asynchronized base station 103 controls the transmission timing thereof based on the result of the measurement in accordance with the procedure in FIG. 30. In the example in this drawing, the frame interval of the asynchronized base station 103 is temporarily lengthened to align the receiving times of the following transport signals at the terminal device: a transport signal from the synchronized base station 101 and a transport signal from the asynchronized base station 103. The frame interval of the synchronized base station is constant.

By the above operation, the following can be implemented at a terminal device located at the cell boundary between a synchronized base station 101 and an asynchronized base station 103 when both the base stations are transmitting identical data signals to achieve soft handover or broadcast: the transport signals from the base stations can be synthesized and received without complicating its reception circuitry and further the transmission power of each of the synchronized base station 101 and the asynchronized base station 103 can be suppressed.

### INDUSTRIAL APPLICABILITY

According to the invention, as mentioned up to this point, the receiver configuration of a terminal device can be simplified in soft handover between base stations in a wireless communication system or inter-base-station synthesis in broadcast service.

### BRIEF DESCRIPTION OF THE DRAWINGS

FIG. 1 This is a schematic diagram of a wireless communication system in a first embodiment.

FIG. 2 This is a network configuration diagram of a wireless communication system in the first embodiment.

FIG. 3 This illustrates an example of radio communication between devices in the first embodiment.

FIG. 4 This is a transmission/reception timing chart of base station apparatuses and a terminal device.

FIG. 5 This is a state transition diagram of an asynchronized base station in the first embodiment.

FIG. 6 This is a flowchart of the processing of an asynchronized base station in the first embodiment in asynchronous mode.

FIG. 7 This is a flowchart of the processing of an asynchronized base station in the first embodiment in calibration mode.

FIG. 8 This is a flowchart of the processing of an asynchronized base station in the first embodiment in synchronous mode.

FIG. 9 This is a flowchart illustrating the determination of transmission timing at an asynchronized base station in the first embodiment.

FIG. 10 This is a timing chart related to FIG. 9.

FIG. 11 This is a block diagram of an asynchronized base station in the first embodiment.

FIG. 12 This is a block diagram of the reception signal estimation unit of an asynchronized base station in the first embodiment.

FIG. 13 This is a drawing illustrating the internal state of the reception signal estimation unit of an asynchronized base station in the first embodiment.

FIG. 14 This is a flowchart of the processing of the reception signal estimation unit of an asynchronized base station in the first embodiment in the no reference signal state.

FIG. 15 This is a flowchart of the processing of the reception signal estimation unit of an asynchronized base station in the first embodiment in the reference signal estimating state.

FIG. 16 This is a flowchart of the processing of the reception signal estimation unit of an asynchronized base station in the first embodiment in the reference signal tracking state.

FIG. 17 This is a drawing illustrating an example of an output result of the reference signal search block of an asynchronized base station in the first embodiment.

FIG. 18 This is a drawing illustrating an example of an output result of the delay profile generation block of an asynchronized base station in the first embodiment.

FIG. 19 This is a block diagram of the target timing generation unit of an asynchronized base station in the first embodiment.

FIG. 20 This is a drawing illustrating the internal state of the target timing generation unit of an asynchronized base station in the first embodiment.

FIG. 21 This is a flowchart of the processing of the target timing generation unit of an asynchronized base station in the first embodiment when its internal state is the timing fixed state.

FIG. 22 This is a flowchart of the processing of the target timing generation unit of an asynchronized base station in the first embodiment when its internal state is the timing change state.

FIG. 23 This is a drawing illustrating an example of a format for recording to an offset information storage memory.

FIG. 24 This is a block diagram of the frame timing generation unit of an asynchronized base station in the first embodiment.

FIG. 25 This is a flowchart of the processing of the frame timing generation unit control block of an asynchronized base station in the first embodiment.

FIG. 26 This is a drawing illustrating an embodiment of a synchronized base station of the invention.

FIG. 27 This is a drawing illustrating an embodiment of a terminal device of the invention.

FIG. 28 This is a drawing illustrating an embodiment of signals between devices in the first embodiment.

FIG. 29 This is a schematic diagram of a wireless communication system in a second embodiment.

FIG. 30 This is a flowchart of a procedure for determining transmission timing at an asynchronized base station in the second embodiment.

FIG. 31 This is a timing chart related to the determination of transmission timing at an asynchronized base station in the second embodiment.

FIG. 32 This is a drawing illustrating an embodiment of signals between devices in the second embodiment.

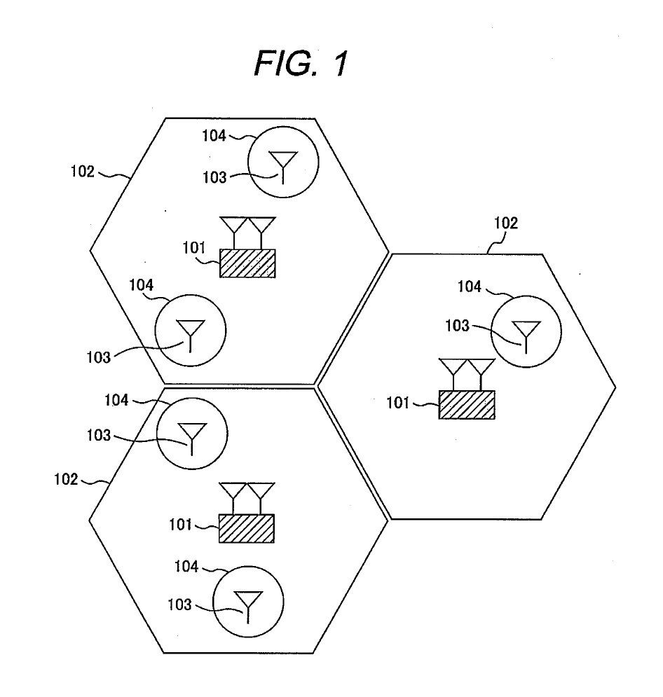

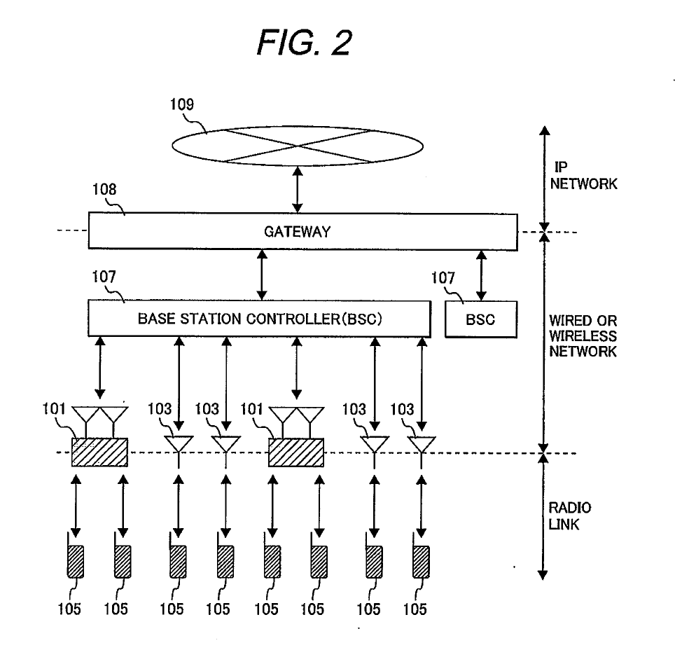

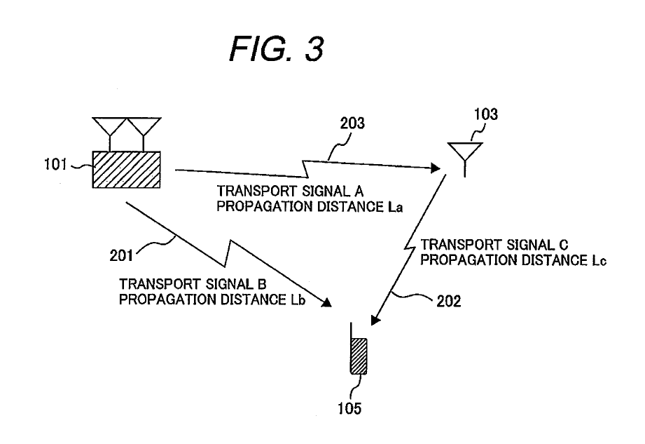

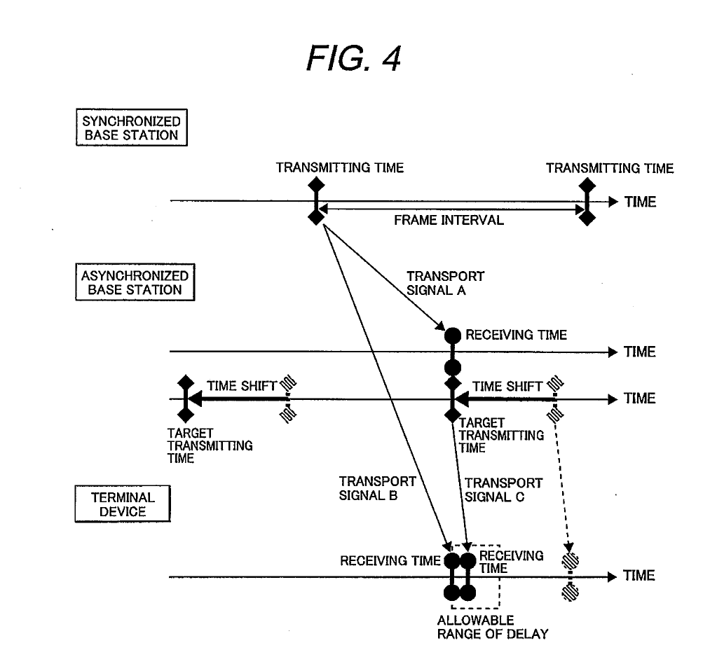

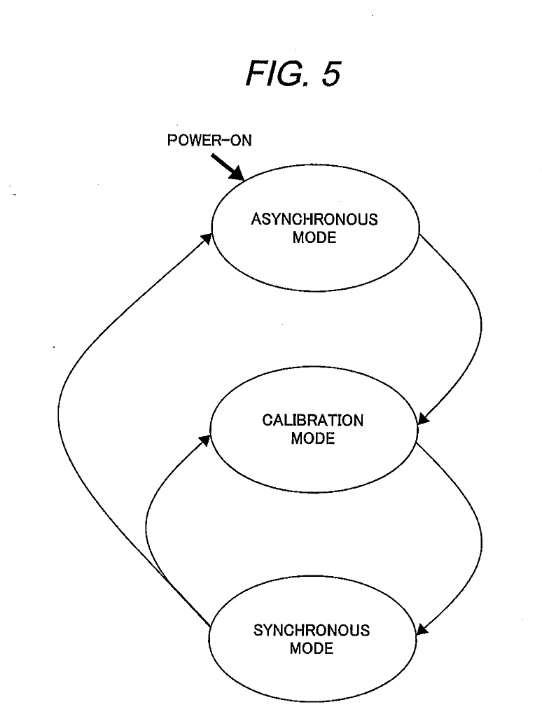

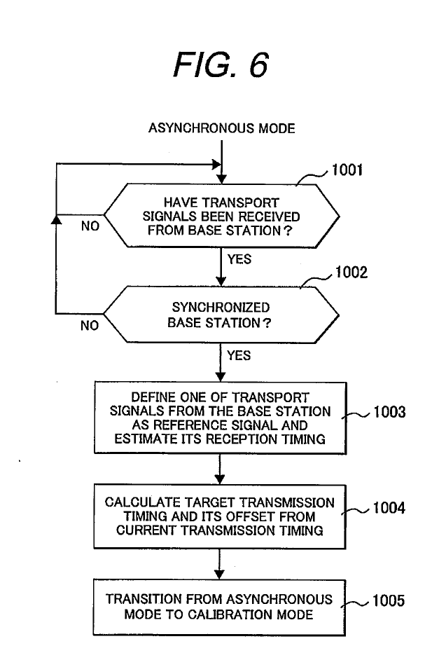

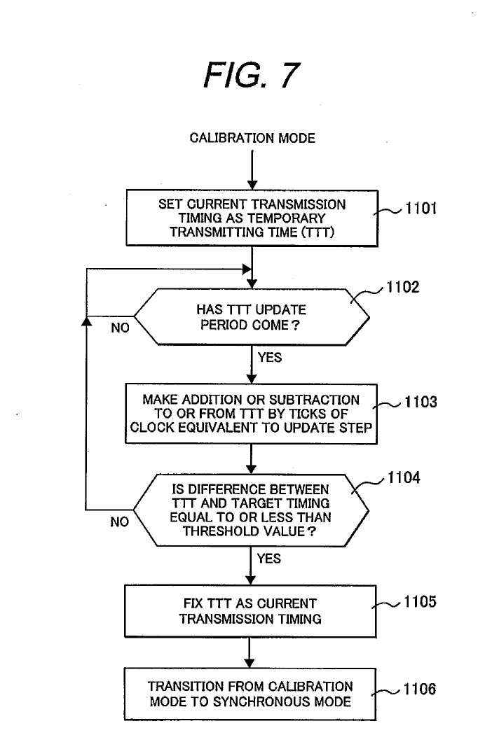

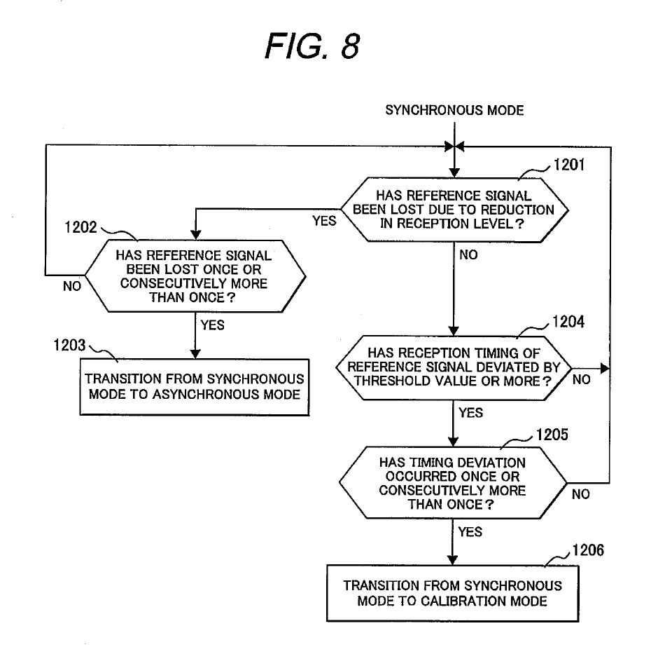

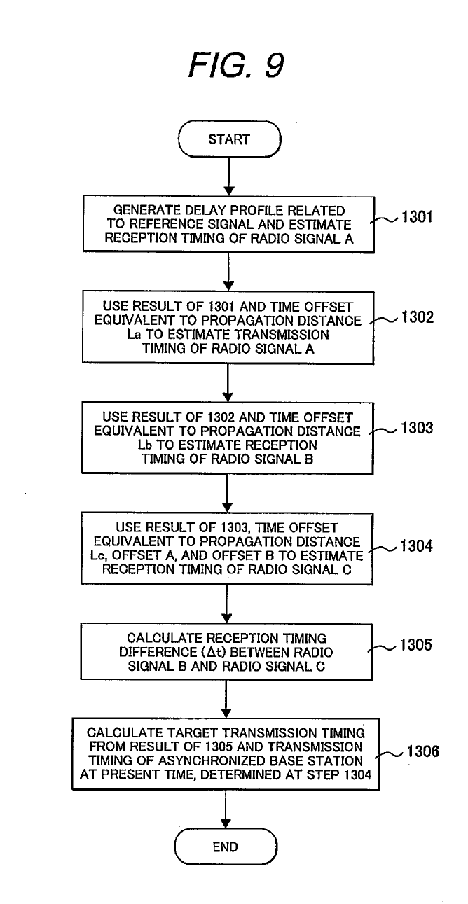

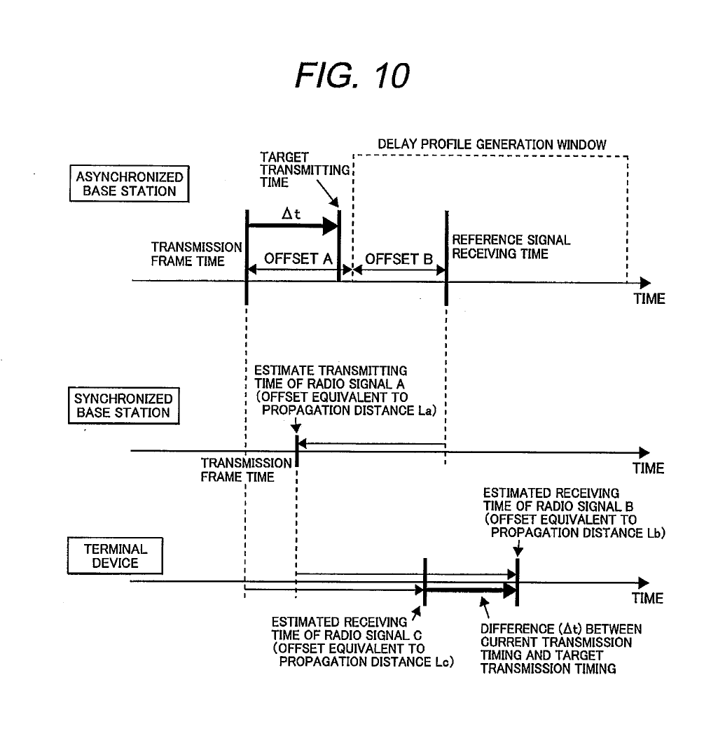

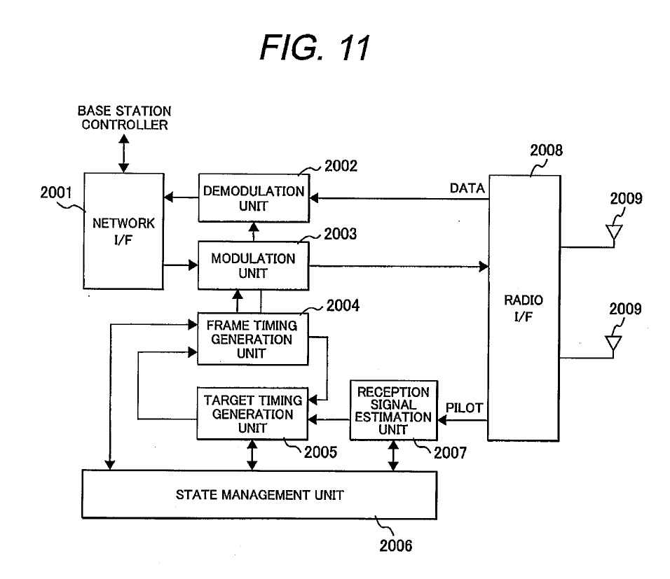

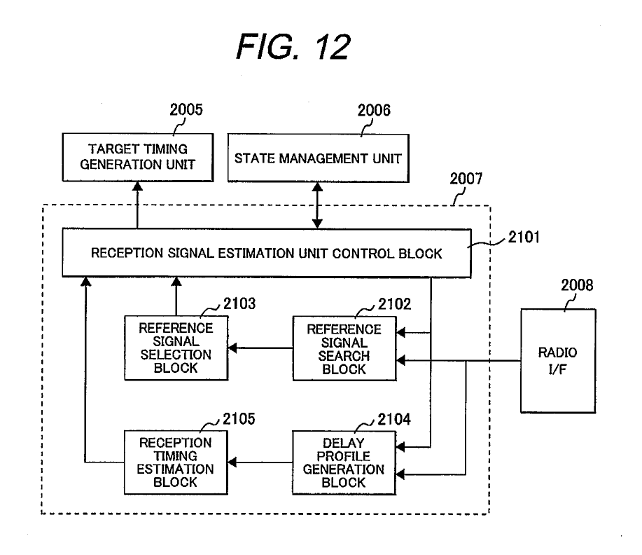

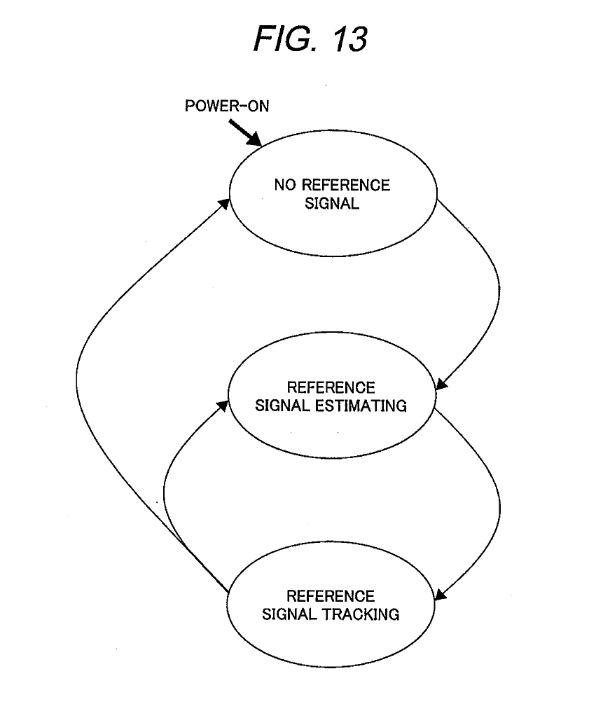

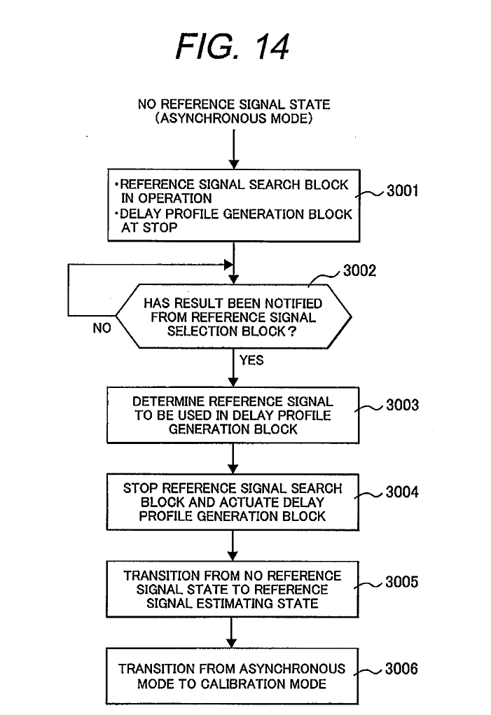

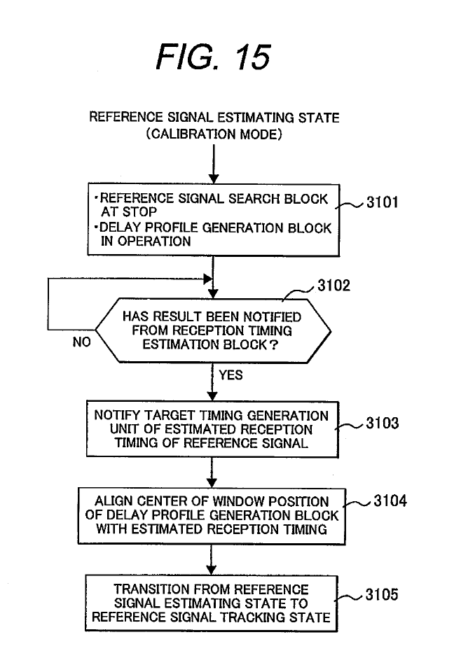

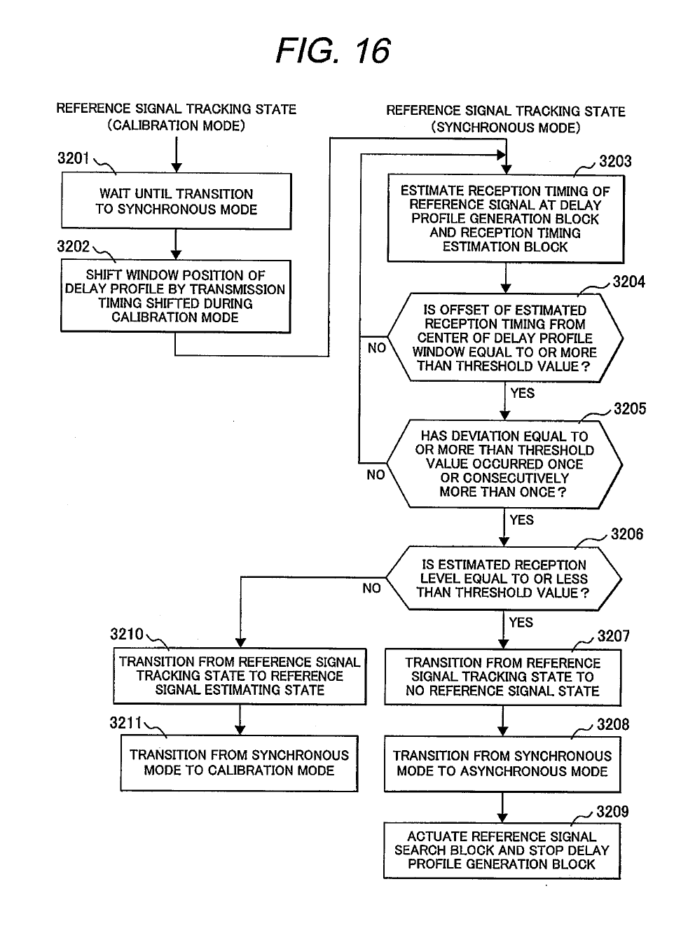

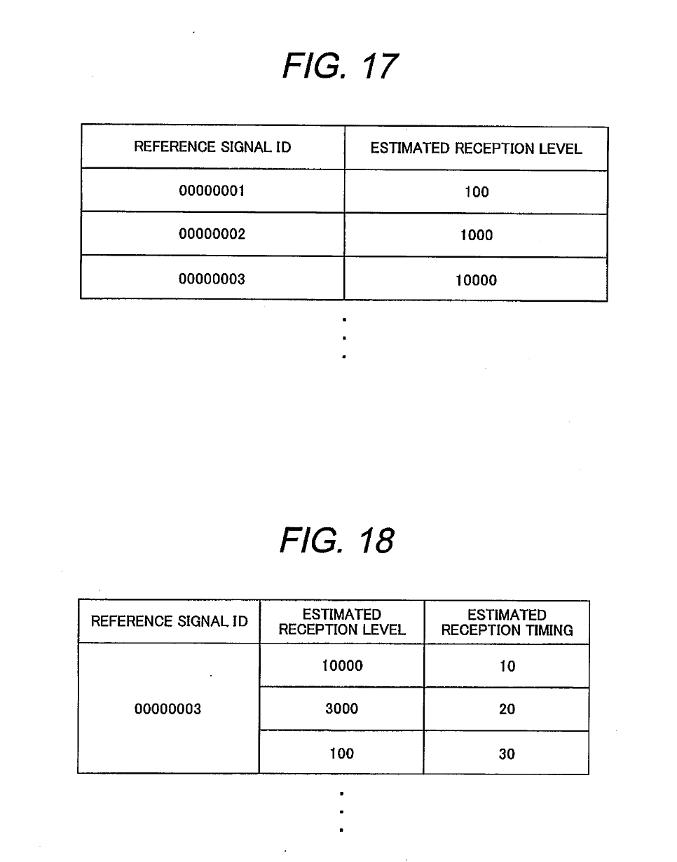

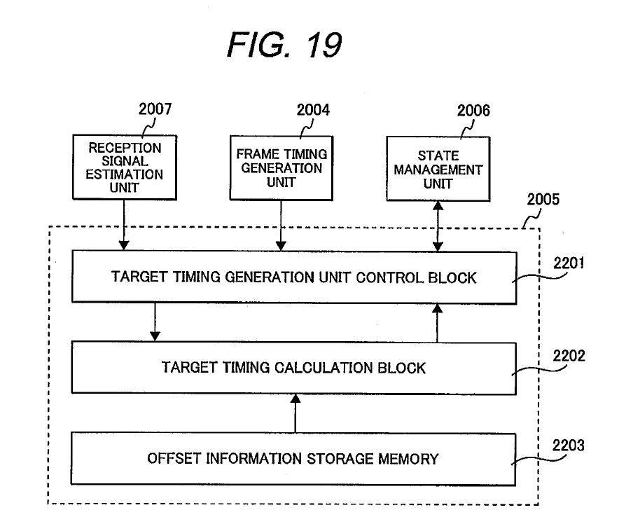

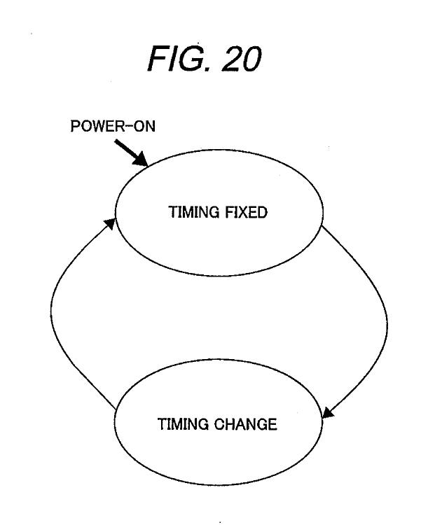

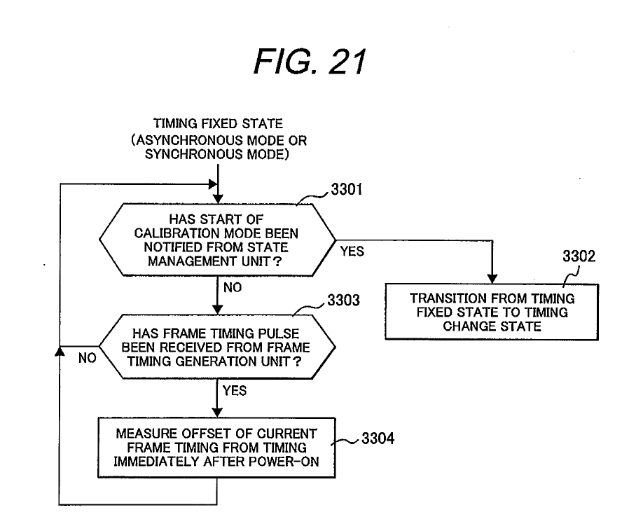

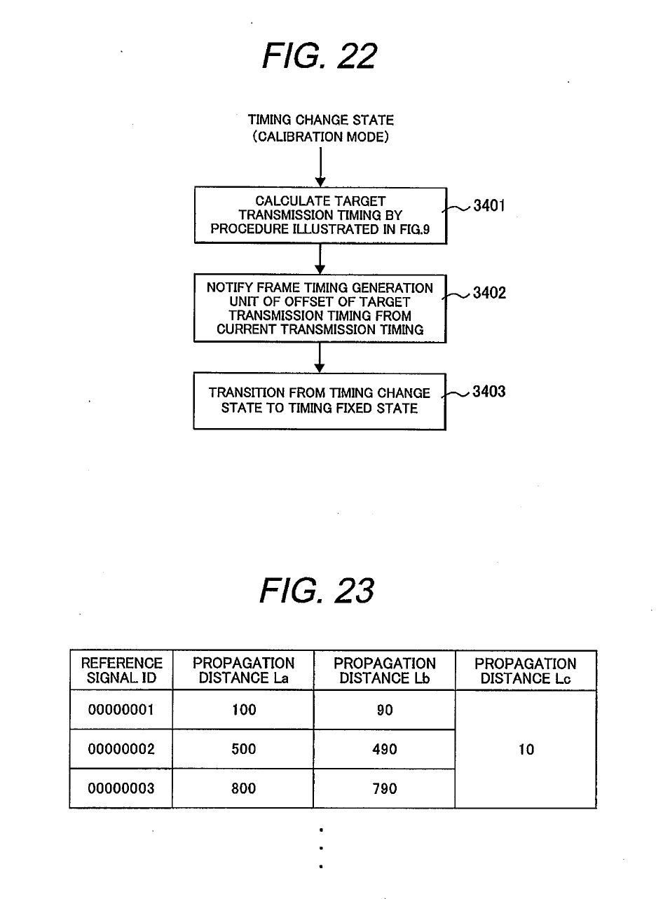

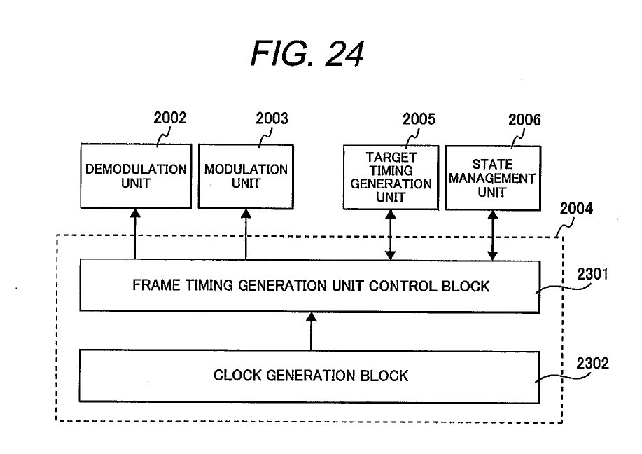

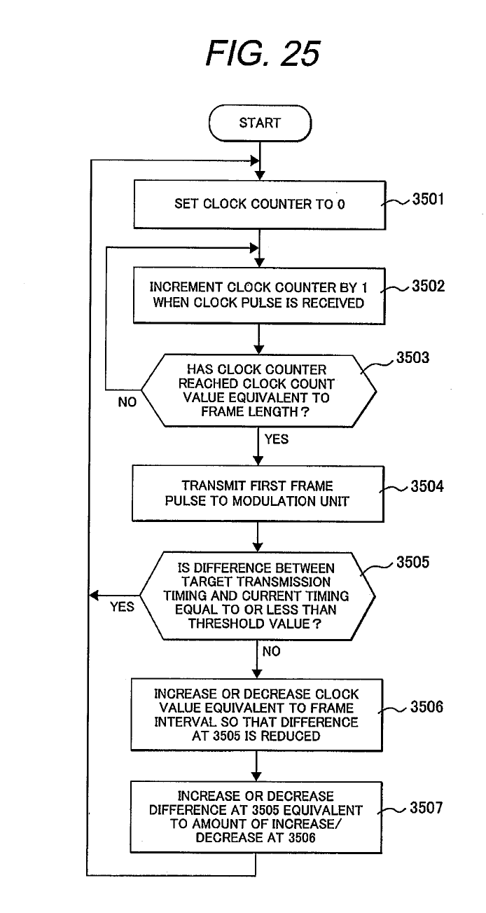

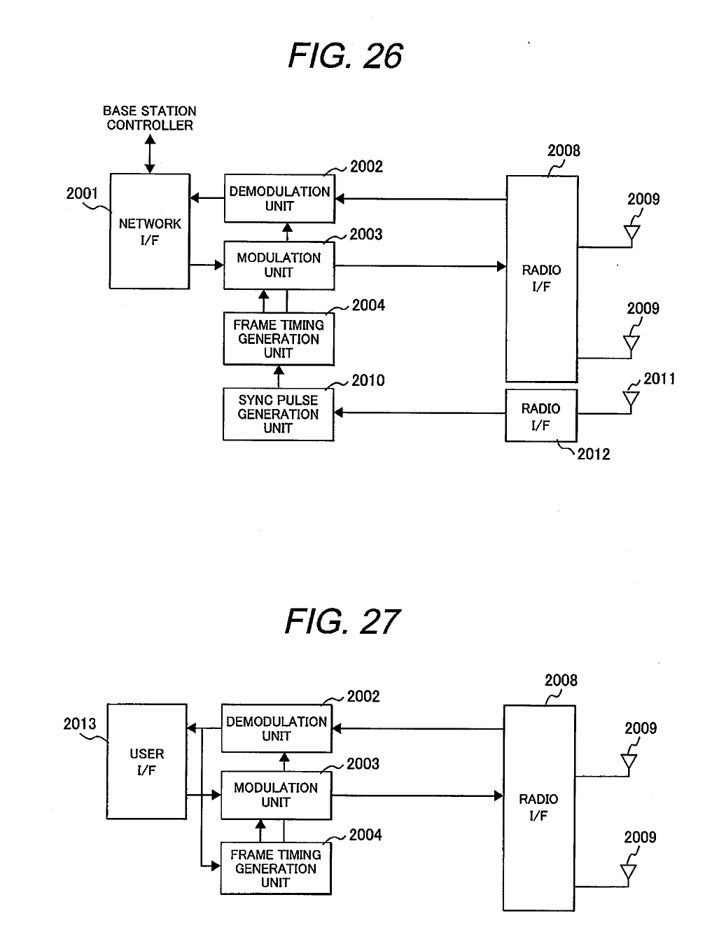

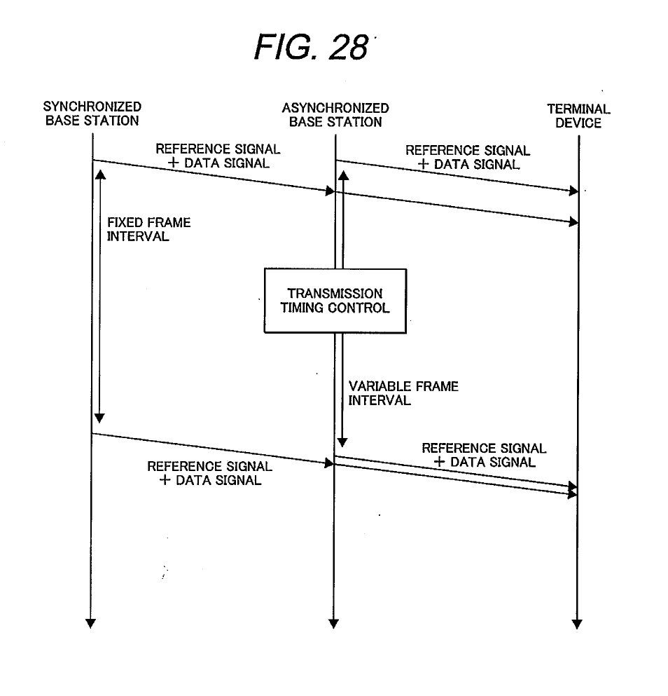

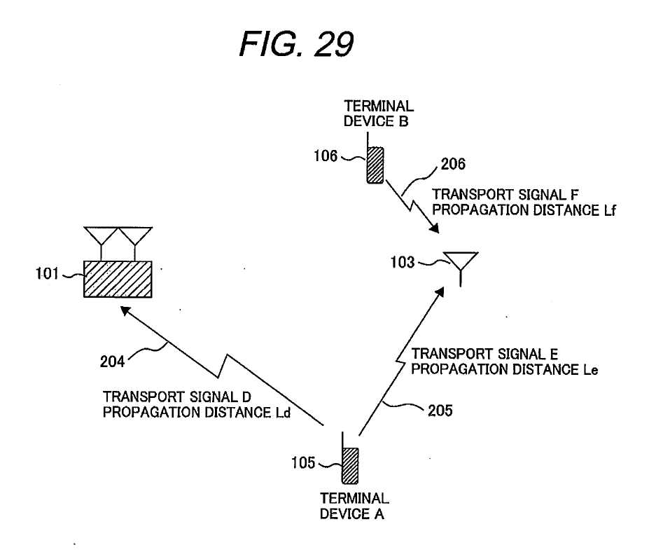

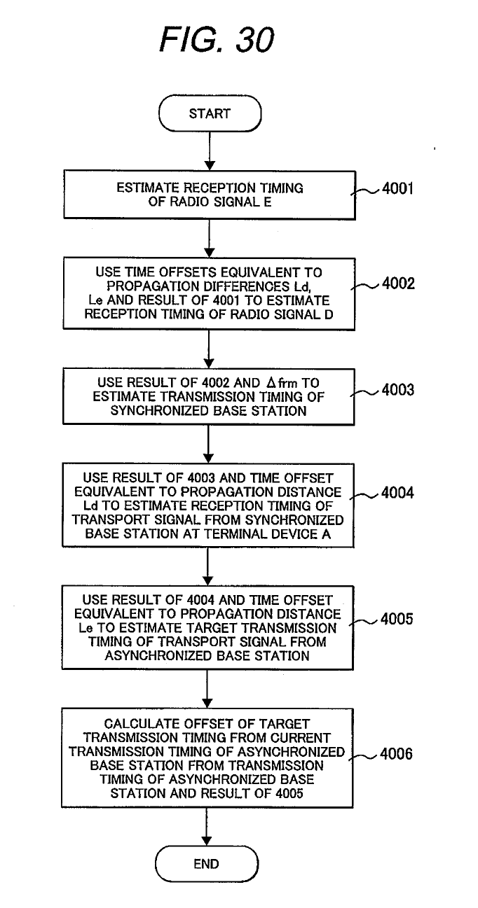

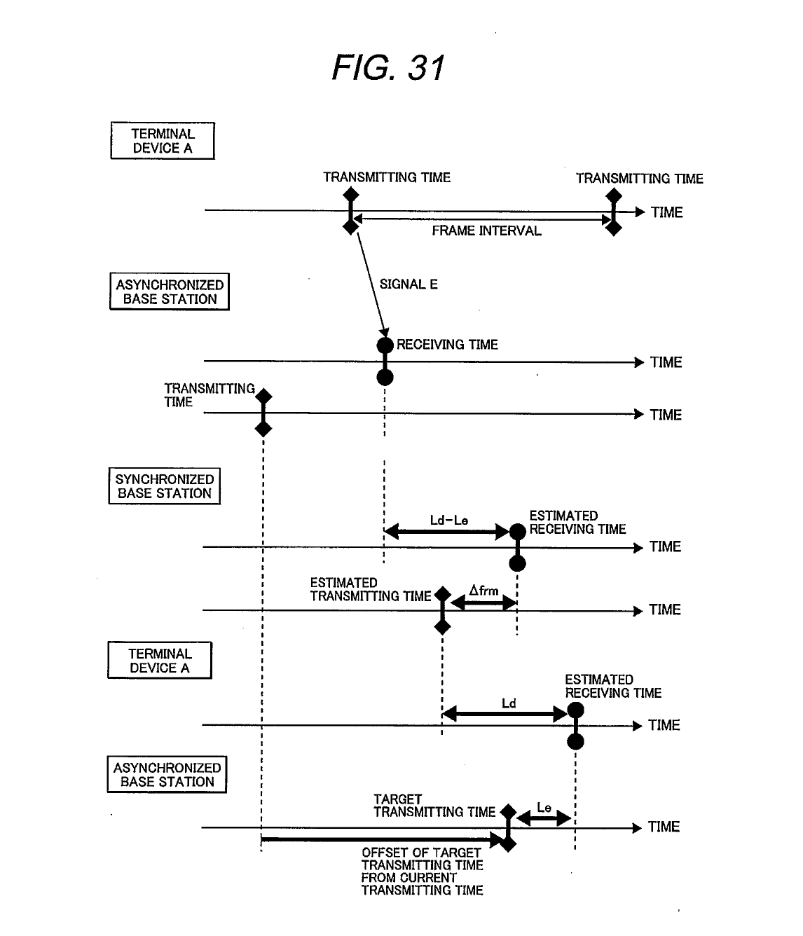

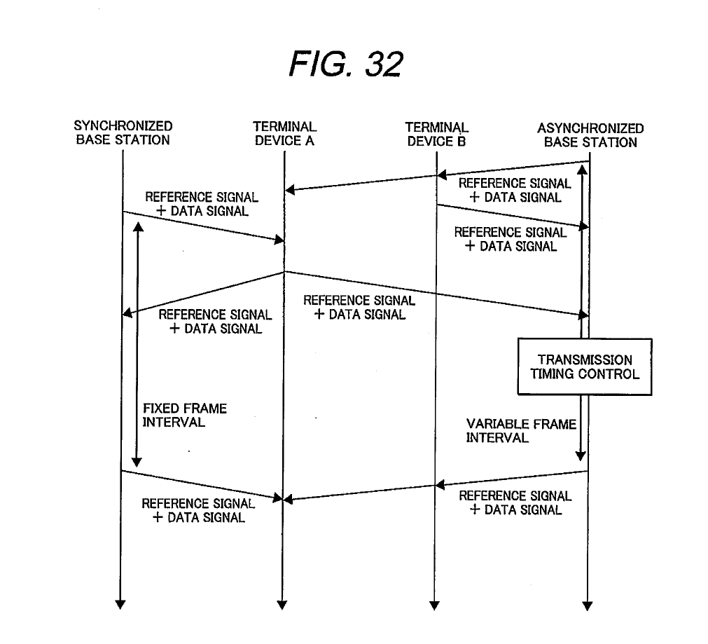

### EXPLANATION OF REFERENCE NUMERALS AND SYMBOLS

101—Synchronized base station
102—Range of cell formed by synchronized base station
103—Asynchronized base station
104—Range of cell formed by asynchronized base station
105—Terminal device A
106—Terminal device B
107—Base station controller
108—Gateway
109—IP network
201—Radio down signal B
202—Radio down signal C
203—Radio down signal A
204—Radio up signal D
205—Radio up signal E
206—Radio up signal F
2001—Network I/F
2002—Demodulation unit
2003—Modulation unit
2004—Frame timing generation unit
2005—Target timing generation unit
2006—State management unit
2007—Reception signal estimation unit
2008—Radio I/F
2009—Transmitting and receiving antenna
2010—Sync pulse generation unit
2011—GPS antenna
2012—Radio I/F for GPS
2013—User I/F
2101—Reception signal estimation unit control block
2102—Reference signal search block
2103—Reference signal selection block
2104—Delay profile generation block
2105—Reception timing estimation block
2201—Target timing generation unit control block
2202—Target timing calculation block
2203—Offset information storage memory
2301—Frame timing generation unit control block
2302—Clock generation block

1. A wireless communication system comprising a first base station synchronizing itself with a base station located in a different cell by a received sync pulse, a second base station located in the cell of the first base station, and a terminal, characterized in that:
the second base station includes:
a unit for determining the reception timing difference between a transport signal transmitted by the first base station and a transport signal transmitted by the second base station, at the terminal; and
a unit for controlling the transmission timing of the second base station so that the reception timing difference becomes equal to or less than a predetermined value.

2. The wireless communication system according to claim 1, characterized in that:
the second base station includes:
a unit for calculating a delay profile of a first transport signal transmitted to the second base station by the first base station and estimating the reception timing of the first transport signal at the second base station based on the delay profile;
a unit for estimating the transmission timing of the first transport signal based on the estimated reception timing of the first transport signal and the distance L1 between the first base station and the second base station;
a unit for estimating the reception timing of a second transport signal, transmitted from the first base station to the terminal with the same timing as the estimated transmission timing of the first transport signal, at the terminal based on the distance L2 between the first base station and the terminal;
a unit for estimating the transmission timing of a third transport signal transmitted to the terminal by the second base station based on a first offset, which is the difference between the frame transmission timing of the second base station and the beginning of a delay profile window of the second base station, and a second offset, which is the difference between the estimated reception timing of the first transport signal and the beginning of the delay profile window;
a unit for estimating the reception timing of the third transport signal at the terminal based on the estimated transmission timing of the third transport signal and the distance L3 between the second base station and the terminal;
a unit for estimating the reception timing difference between the estimated reception timing of the second transport signal and the reception timing of the third transport signal; and
a unit for newly setting the transmission timing of the third transport signal based on the estimated transmission timing of the third transport signal and the estimated reception timing difference.

3. The wireless communication system according to claim 1, characterized in that:
the second base station includes:
a unit for estimating the reception timing of a fourth transport signal, transmitted from the terminal to the second base station, at the second base station;
a unit for estimating the reception timing of a fifth transport signal, transmitted from the terminal to the first base station, at the first base station based on the propagation path difference between the distance L4 between the terminal and the second base station and the distance L5 between the terminal and the first base station;
a unit for estimating the transmission timing of the first base station based on the difference between transmission frame timing and reception frame timing at the first base station and the reception timing of the fifth transport signal;
a unit for estimating first reception timing of a first down signal, transmitted from the first base station to the terminal, at the terminal based on the distance L5; and
a unit for newly setting the transmission timing of a second down signal transmitted from the second base station to the terminal based on the reception timing of the down signal and the distance L4.

4. The wireless communication system according to claim 2, characterized in that:
the transmission timing of the first transport signal is estimated based on the estimated reception timing of the first transport signal and a time calculated by multiplying the distance L1 by the speed of light,
the reception timing of the second transport signal is estimated based on a time calculated by multiplying the distance L2 by the speed of light and the estimated transmission timing of the first transport signal, and
the reception timing of the third transport signal is estimated based on the estimated transmission timing of the third transport signal and a time calculated by multiplying the distance L3 by the speed of light.

5. The wireless communication system according to claim 3, characterized in that:
the reception timing of the fifth transport signal is estimated based on a time calculated by multiplying the propagation path difference between the distance L4 and the distance L5 by the speed of light,
first reception timing of the first down signal is estimated based on a time calculated by multiplying the distance L5 by the speed of light, and
second reception timing of the second down signal is estimated based on the reception timing of the down signal and a time calculated by multiplying the distance L4 by the speed of light.

6. An inter-base-station synchronization method for a first base station and a second base station that wirelessly communicate with a terminal, characterized in that:
the first base station synchronizes itself with a base station in a different cell by a received sync pulse,
the second base station is located in the cell of the first base station,
the reception timing difference between a transport signal transmitted by the first base station and a transport signal transmitted by the second base station at the terminal is determined, and
the transmission timing of the second base station is controlled so that the reception timing difference becomes equal to or less than a predetermined value.

7. The inter-base-station synchronization method according to claim 6, characterized in that:
a delay profile of a first transport signal transmitted to the second base station by the first base station is calculated and the reception timing of the first transport signal at the second base station is estimated based on the delay profile,
the transmission timing of the first transport signal is estimated based the estimated reception timing of the first transport signal and the distance L1 between the first base station and the second base station,
the reception timing of the second transport signal, transmitted from the first base station to the terminal with the same timing as the estimated transmission timing of the first transport signal, at the terminal is estimated based on the distance L2 between the first base station and the terminal,
the transmission timing of a third transport signal, transmitted to the terminal by the second base station, is estimated based on a first offset, which is the difference between the frame transmission timing of the second base station and the beginning of a delay profile window of the second base station, and a second offset, which is the difference between the estimated reception timing of the first transport signal and the beginning of the delay profile window,
the reception timing of the third transport signal at the terminal is estimated based the estimated transmission timing of the third transport signal and the distance L3 between the second base station and the terminal,
the reception timing difference between the estimated reception timing of the second transport signal and the reception timing of the third transport signal is estimated, and
the transmission timing of the third transport signal is newly set based on the estimated transmission timing of the third transport signal and the estimated reception timing difference.

8. The inter-base-station synchronization method according to claim 6, characterized in that:
the reception timing of a fourth transport signal, transmitted from the terminal to the second base station, at the second base station is estimated,
the reception timing of a fifth transport signal, transmitted from the terminal to the first base station, at the first base station is estimated based on the propagation path difference between the distance L4 between the terminal and the second base station and the distance L5 between the terminal and the first base station,
the transmission timing of the first base station is estimated based on the difference between transmission frame timing and reception frame timing at the first base station and the reception timing of the fifth transport signal,
first reception timing of a first down signal, transmitted from the first base station to the terminal, at the terminal is estimated based on the distance L5, and
the transmission timing of a second down signal, transmitted from the second base station to the terminal, is newly set based on the reception timing of the down signal and the distance L4.

9. The inter-base-station synchronization method according to claim 7, characterized in that:
the transmission timing of the first transport signal is estimated based on the estimated reception timing of the first transport signal and a time calculated by multiplying the distance L1 by the speed of light,
the reception timing of the second transport signal is estimated based on a time calculated by multiplying the distance L2 by the speed of light and the estimated transmission timing of the first transport signal, and
the reception timing of the third transport signal is estimated based on the estimated transmission timing of the third transport signal and a time calculated by multiplying the distance L3 by the speed of light.

10. The inter-base-station synchronization method according to claim 8, characterized in that:
the reception timing of the fifth transport signal is estimated based on a time calculated by multiplying the propagation path difference between the distance L4 and the distance L5 by the speed of light,
first reception timing of the first down signal is estimated based on a time calculated by multiplying the distance L5 by the speed of light, and
second reception timing of the second down signal is estimated based on the reception timing of the down signal and a time calculated by multiplying the distance L4 by the speed of light.

11. A low-output base station wirelessly communicating with a terminal, located in the cell of a high-output base station synchronizing itself with a base station in a different cell by a received sync pulse, and lower in output power than the high-output base station, characterized in that the low-output base station comprises:
a unit for determining the reception timing difference between a transport signal transmitted by the high-output base station and a transport signal transmitted by the low-output base station at the terminal; and
a unit for controlling the transmission timing of the low-output base station so that the reception timing difference becomes equal to or less than a predetermined value.

12. The low-output base station according to claim 11, characterized in that the low-output base station comprises:
a unit for calculating a delay profile of a first transport signal transmitted to the low-output base station by the high-output base station and estimating the reception timing of the first transport signal at the low-output base station based on the delay profile;
a unit for estimating the transmission timing of the first transport signal based on the estimated reception timing of the first transport signal and the distance L1 between the high-output base station and the low-output base station;
a unit for estimating the reception timing of a second transport signal, transmitted from the high-output base station to the terminal with the same timing as the estimated transmission timing of the first transport signal, at the terminal based on the distance L2 between the high-output base station and the terminal;
a unit for estimating the transmission timing of a third transport signal transmitted to the terminal by the low-output base station based on a first offset, which is the difference between the frame transmission timing of the low-output base station and the beginning of a delay profile window of the low-output base station, and a second offset, which is the difference between the estimated reception timing of the first transport signal and the beginning of the delay profile window;
a unit for estimating the reception timing of the third transport signal at the terminal based on the estimated transmission timing of the third transport signal and the distance L3 between the low-output base station and the terminal;
a unit for estimating the reception timing difference between the estimated reception timing of the second transport signal and the reception timing of the third transport signal; and
a unit for newly setting the transmission timing of the third transport signal based on the estimated transmission timing of the third transport signal and the estimated reception timing difference.

13. The low-output base station according to claim 11, characterized in that the low-output base station comprises:
a unit for estimating the reception timing of a fourth transport signal, transmitted from the terminal to the low-output base station, at the low-output base station;
a unit for estimating the reception timing of a fifth transport signal, transmitted from the terminal to the high-output terminal, at the high-output base station based on the propagation path difference between the distance L4 between the terminal and the low-output base station and the distance L5 between the terminal and the high-output base station;
a unit for estimating the transmission timing of the high-output base station based on the difference between transmission frame timing and reception frame timing at the high-output base station and the reception timing of the fifth transport signal;
a unit for estimating first reception timing of a first down signal, transmitted from the high-output base station to the terminal, at the terminal based on the distance L5; and
a unit for newly setting the transmission timing of a second down signal transmitted from the low-output base station to the terminal based on the reception timing of the down signal and the distance L4.

14. The low-output base station according to claim 12, characterized in that:
the transmission timing of the first transport signal is estimated based on the estimated reception timing of the first transport signal and a time calculated by multiplying the distance L1 by the speed of light;
the reception timing of the second transport signal is estimated based on a time calculated by multiplying the distance L2 by the speed of light and the estimated transmission timing of the first transport signal; and
the reception timing of the third transport signal is estimated based on the estimated transmission timing of the third transport signal and a time calculated by multiplying the distance L3 by the speed of light.

15. The low-output base station according to claim 13, characterized in that:
the reception timing of the fifth transport timing is estimated based on a time calculated by multiplying the propagation path difference between the distance L4 and the distance L5 by the speed of light;
first reception timing of the first down signal is estimated based on a time calculated by multiplying the distance L5 by the speed of light; and
second reception timing of the second down signal is estimated based on the reception timing of the down signal and a time calculated by multiplying the distance L4 by the speed of light.

16. The low-output base station according to claim 11, characterized in that the low-output base station comprises a memory for storing the distances L1, L2 and L3.

17. The low-output base station according to claim 11, characterized in that the low-output base station has:
asynchronous mode in which synchronization with a high-output base station is not ensured;
calibration mode in which the transmission timing of the low-output base station is varied so that the reception timing difference becomes equal to or less than a predetermined value; and
synchronous mode in which the reception timing difference becomes equal to or less than the predetermined value and the transmission timing of the low-output base station is locked, and comprises:
a state management unit for managing the modes.
